(19) United States
(12) Patent Application Publication
(10) Pub. No.: US 2012/0229623 A1
(43) Pub. Date: Sep. 13, 2012

(54) Pendulum-type landslide monitoring system

(76) Inventors: How-Jung Hsieh, Taichung City (TW); Tsu-Kuang Hsieh, Taichung City (TW)

(21) Appl. No.: 13/200,263

(22) Filed: Sep. 22, 2011

(30) Foreign Application Priority Data
Mar. 8, 2011 (TW) 100204101

(51) Int. Cl. H04N 7/18

(52) U.S. Cl. 348/135; 348/E07.085

(57) ABSTRACT

A pendulum-type landslide monitoring system includes an outer tube for being implanted into a ground to be monitored; a plurality of measuring units, vertically aligned inside the outer tube for independently measuring displacement at different depths in the ground; a guiding tube inside the outer tube for a flexible image capturing device to pass therethrough; and a water-level monitoring tube installed in the outer tube. Thereby, the flexible image capturing device can capture data of the displacement obtained by the measuring units, for an operator to identify displacement of a sliding surface in the ground, and to visually observe images of flowing groundwater captured by the flexible image capturing device in the outer tube, in order to further determining groundwater flow patterns as well stratums in the ground.

### BACKGROUND OF THE INVENTION

1. Technical Field

The present invention relates to technologies for monitoring landslide and groundwater, and more particularly, to a pendulum-type landslide monitoring system that implements an in-place camera to capture images of readings related to underground displacement, thereby collecting intuitional and accurate geological data for further analysis.

2. Description of Related Art

Currently, monitoring landslide as at slopes is accomplished by two major approaches. One is to directly observe sliding surfaces' displacement and the other is to monitor groundwater.

Conventionally, following devices and/or schemes are used to monitor sliding surfaces' displacement:

(1) Landslide measuring tube: a measuring tube containing ropes of various lengths is placed in an observation well previously drilled at a slope to be watched. In response to landslide, the measuring tube can get deformed so that those ropes with their portions under the deformed site on the tube are gripped by the deformed measuring tube and can not be pulled upward freely. Thus an operator can figure out the depth where the landslide has taken place by pulling the ropes to check their movability. However, this scheme can only show the depth of the displacement, but not the size and direction of the displacement.

(2) Pipe strain gauge: in a measuring tube a plurality of strainer are arranged equidistantly. By calculating resistance values of the strainers, the displacement taking place at the site with the strain gauge is installed can be determined. Although this approach further informs users of the depth and size of the displacement, the measured data are in the form of resistance variation, and need to be further processed and converted into numerical displacement data, being inconvenient. Moreover, since each strainer is wired to a respective monitoring device overground, in case of cable failure or cable breakage, the repair work would be difficult.

(3) In-place inclinometer: a measuring tube is first implanted into the ground for allowing an inclination sensor to measure inclinations of the measuring tube at different depths underground. The measured inclinations can be then processed through trigonometric operations to tell the horizontal displacement size of the measuring tube taking place during landslide. In other words, the displacement is determined by analyzing the variation of the inclinations. However, in this approach, the inclinations have to be converted into numerical displacement data for measurement. In addition, this approach can fail where the measuring tube deforms seriously, because the inclination sensor in that case can be undesirably gripped and blocked from going downward further or coming back up overground.

(4) Borehole extensometer: a plastic tube is inserted to a stable laccolith with nodes provided every one meter underground. Stainless steel strings fixed to the laccolith or the nodes at different length have their free ends led to a measuring board settled overground. When landslide takes place down to a certain depth, the steel strings below this depth can all extend. Thus, the extension of the steel strings measured by the measuring board can be used to analyze the landslide in both size and speed. However, without knowing the exact depth of the sliding surface, as many strings as possible have to be provided for the device. Thus, the installation is inconvenient and measurement errors tend to occur.

(5) Optical-fiber landslide measuring system: this system is composed of a fiber-grating landslide measuring tube and a doubly hinged fiber Bragg grating sensored ground displacement monitoring device. The wavelength variation of light reflected by fiber grating is transferred to and analyzed by a computer. This approach also involves complex calculation and deduction, and therefore may also have deviation. In addition, this approach requires operators with some professional knowledge in the technology to correctly interpret the observed results.

(6) Time domain reflectometry: a coaxial cable is installed as a continuous sensor for detecting landslide through variation of electromagnetic waveforms. TDR is a measuring technology for locating cable failure by measuring the characteristic impedance of the cable. Where a signal passing the cable meets an impedance discontinuity, it is reflected partially or entirely. The delay, size and polarity of the reflected signal indicate the location and nature of the impedance discontinuity along the electric cable. Similar to the foregoing optical-fiber landslide measuring system, the measured results have to be converted into useful data through operation and analysis, and also have the defect of failing to get accurate amount of displacement. On the other hand, since the process involved is relatively complicated, the time consumed by the measurement is relatively long. Also, this approach requires operators with some professional knowledge in the technology to correctly interpret the observed results.

### 2. Groundwater Monitoring:

Since the variation of groundwater is another major cause of landslide and slope failure, in the context of monitoring a sliding surface, groundwater have to be monitored as well in both its flow pattern and level. For identifying groundwater pattern, two major approaches currently used are:

(1) Groundwater counter map: wells are drilled above the sliding surface to be watched for collecting groundwater levels in the wells. The collected groundwater level data are then used to produce a groundwater counter map and in turn derive the flow pattern underground. As this approach is based on conjecture, it tends to have significant inaccuracy.

(2) Dye-tracing technology: a stain or fluorescent agent is placed into a well above a slope or a groundwater fountainhead. After a period of time, observation is performed at downstream observation wells using in-place cameras and the groundwater flow path can be determined basing on where the groundwater observed is colored. However, the stain or fluorescent agent, after diffusion in the water, can present in a concentration too low to be visually detected and has to be determined by sampling and testing in labs, causing this approach time-consuming. In addition, since the stain or fluorescent agent can diffuse throughout a well at all depths, this approach can only tell whether there is stain or fluorescent agent existing. As to the exact depth where the groundwater passes, it has to resort to further logging tests.

From above, it is learned that all the existing approaches for investigating into landslide involve transferring such physical phenomena as strains, inclinations, extensions measured by measuring tubes, optical fibers and electric cables implemented in the ground to receivers overground, and then analyzing the received data manually or by computer, so as to determine the displacement sizes. On the other hand, the investigation into groundwater needs to sample and test groundwater. Thus, the foregoing measures directed to sliding surfaces, distances and groundwater are all indirect measuring methods.

The inventor of the present invention who has years of experience in teaching and researching landslide monitoring therefore proposes a pendulum-type landslide monitoring system for overcoming the shortcomings of the prior arts. The disclosed monitoring system implements a flexible in-place camera to take images of scales in a measuring tube, so that an operator can directly read the readings related to landslide and visually observe underground structure as well as groundwater variation at the vicinity of the measuring tube. This scheme is intuitional and accurate opposite to the indirect measuring of all the above-mentioned conventional approaches and thus is novel and advantageous.

### SUMMARY OF THE INVENTION

The conventional landslide monitoring approaches are all related to indirect detection that require further operation or processing, and fail to directly inform operators of landslide depth, size and direction. Thus, the measurement disadvantageously consumes time and tends to have inaccuracy. For identifying groundwater patterns, the conventional approaches also tends to have inaccuracy, and can only indicate groundwater profiles in a certain planes but not the overall flow patterns at all depths. With the attempt to overcome the foregoing shortcomings, the present invention provides a pendulum-type landslide monitoring system.

The present invention provides a pendulum-type landslide monitoring system that comprises: an outer tube for being implanted into a ground to be monitored; a plurality of measuring units vertically aligned inside the outer tube for independently measuring displacement at different depths in the ground; and a guiding tube inside the outer tube for a flexible image capturing device to pass therethrough so that the flexible image capturing device is capable of moving along the guiding tube and capturing images outside the outer tube, whereby the flexible image capturing device along the guiding tube captures displacement data measured by the measuring units, thereby facilitating determining displacement of a sliding surface in the ground, and facilitating identifying groundwater levels and patterns by using images of flowing groundwater in the ground captured by the flexible image capturing device.

In one aspect of the present invention, the flexible image capturing device working with the guiding tube and the measuring unit allows accurate measuring of landslide depth, size and direction by using the in-place camera.

In another aspect of the present invention, the outer tube has therein a water-level monitoring tube that communicates with the exterior of the outer tube and allows groundwater to flow therein, so that images of the groundwater in the water-level monitoring tube taken by the in-place camera can accurately reflect the groundwater levels and the ground status outside the outer tube.

In another aspect of the present invention, the flexible image capturing device uses an in-place camera to directly capture dynamic or static images of the measuring units, so the visually presented readings related to landslide and groundwater are numerical data for immediate use but not raw data to be processed, thereby saving measuring time and ensuring measuring accuracy.

In another aspect of the present invention, the two vertically adjacent measuring units are such set that their working directions are perpendicular, e.g. having their working directions being east-west going and north-south going, respectively. Such a combination allows accurate measurement of the sliding direction of the sliding surface, so as to allow accurate determination of the sliding azimuth of the sliding surface.

In another aspect of the present invention, the frame has a length equal to four times of the distance between the crossbeam and any of the gauges. This design has been optimized through feasibility tests in the swing movement of the plumbline and in turn the pendulum to facilitate convenient calculation.

In still another aspect of the present invention, the flexible image capturing device can faithfully take clear images of the displacement of the outer tube at different depths through the windows formed on the guiding tube corresponding to the measuring units.

In yet another aspect of the present invention, the flexible image capturing device may be an IR thermometry camera that can sense the temperature of the ground, so that the temperatures measured at different depths underground can be used to derive the groundwater flow patterns.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic drawing showing an environment where the present invention is applied;

FIG. 2 illustrates installation of the present invention;

FIG. 3 is a perspective view of a frame of the present invention;

FIG. 4 is a partial, exploded view of the present invention;

FIG. 5 is a top view of the present invention showing a crossbeam thereof;

FIG. 6 is another top view of the present invention further showing a gauge thereof;

FIG. 7 is a schematic drawing showing that the ground in which the present invention is installed has slid;

FIG. 8 shows the present invention in the ground without displacement;

FIG. 9 shows the present invention in the ground that has slid to ward the valley;

FIG. 10 shows the present invention in the ground that has slid to ward the slope; and

FIG. 11 explains determination of east-west displacement and north-south displacement of the sliding surface according to the present invention.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made to exact scale. Unless otherwise noted, like elements will be identified by identical numbers throughout all figures.

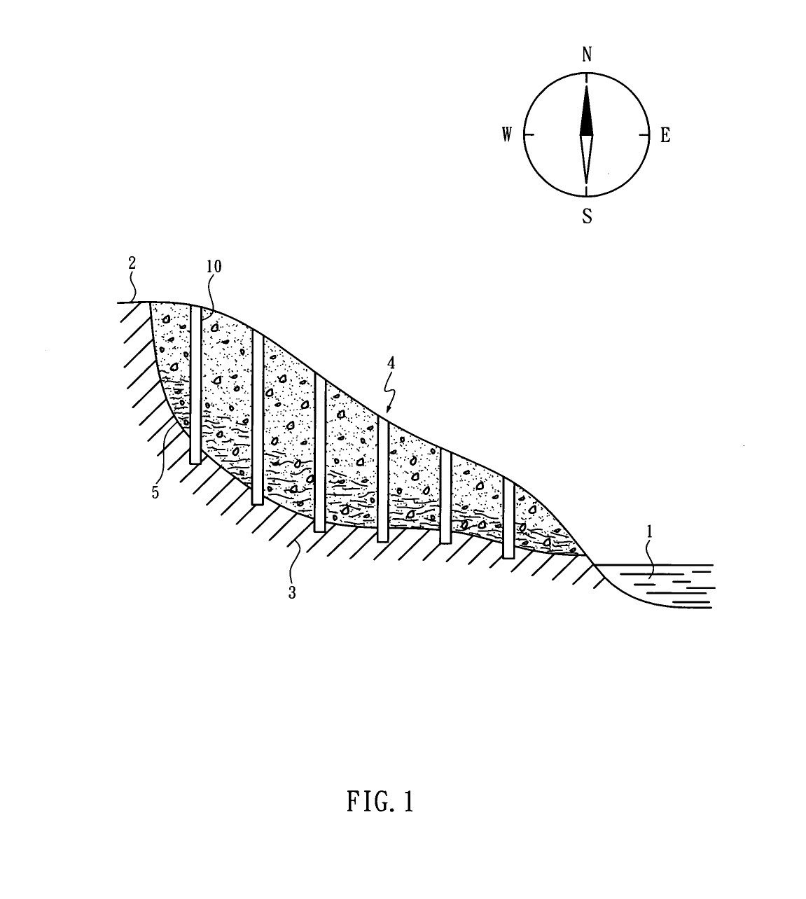

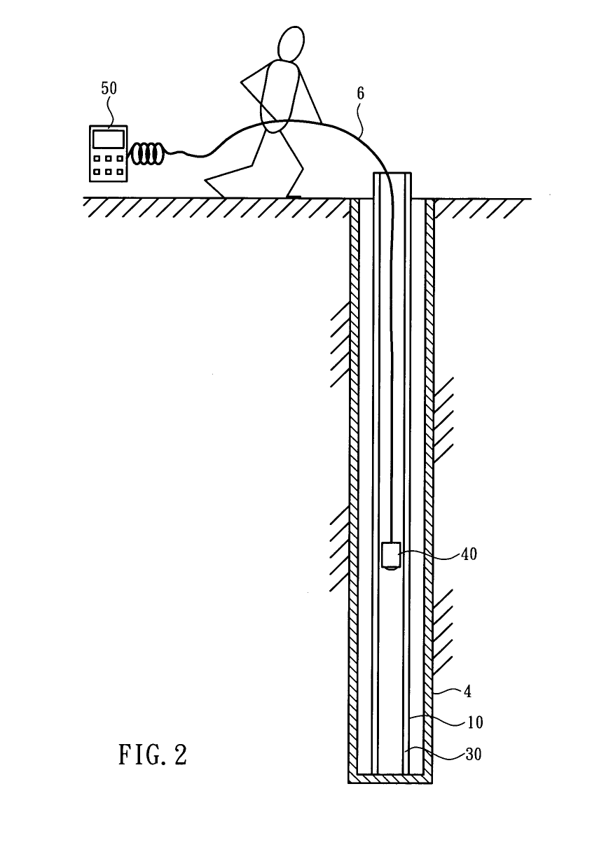

Referring to FIG. 1 and FIG. 2, a pendulum-type landslide monitoring system of the present invention is to be installed on a laccolith 3 under a slope 2 near a valley 1. Plural said monitoring systems are installed in a plurality of observation wells 4 predrilled for monitoring the sliding angle and displacement amount of a sliding surface 5, as well as groundwater level and groundwater flow patterns.

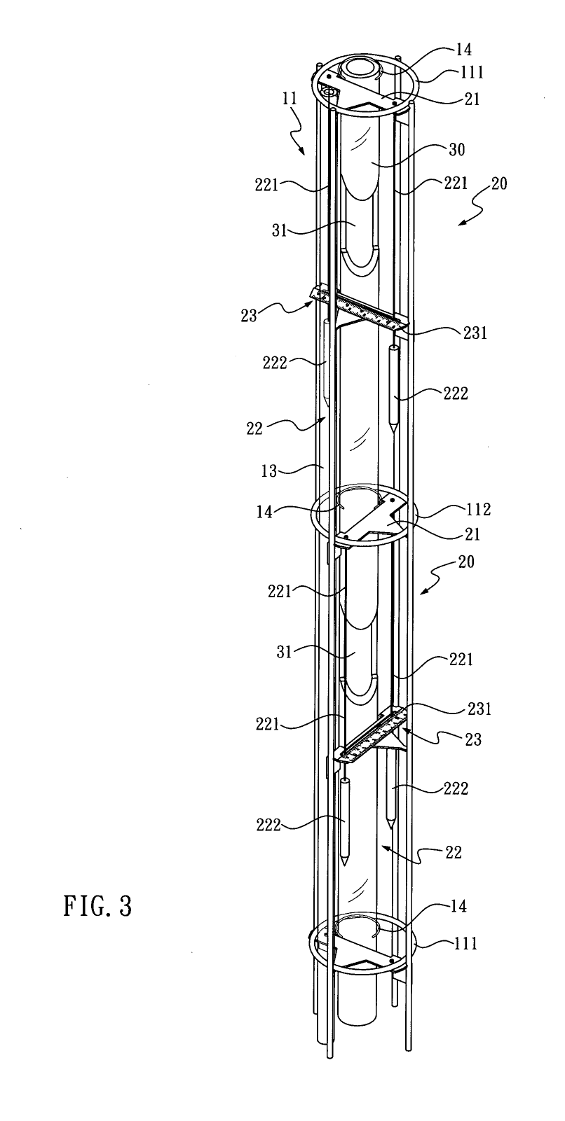

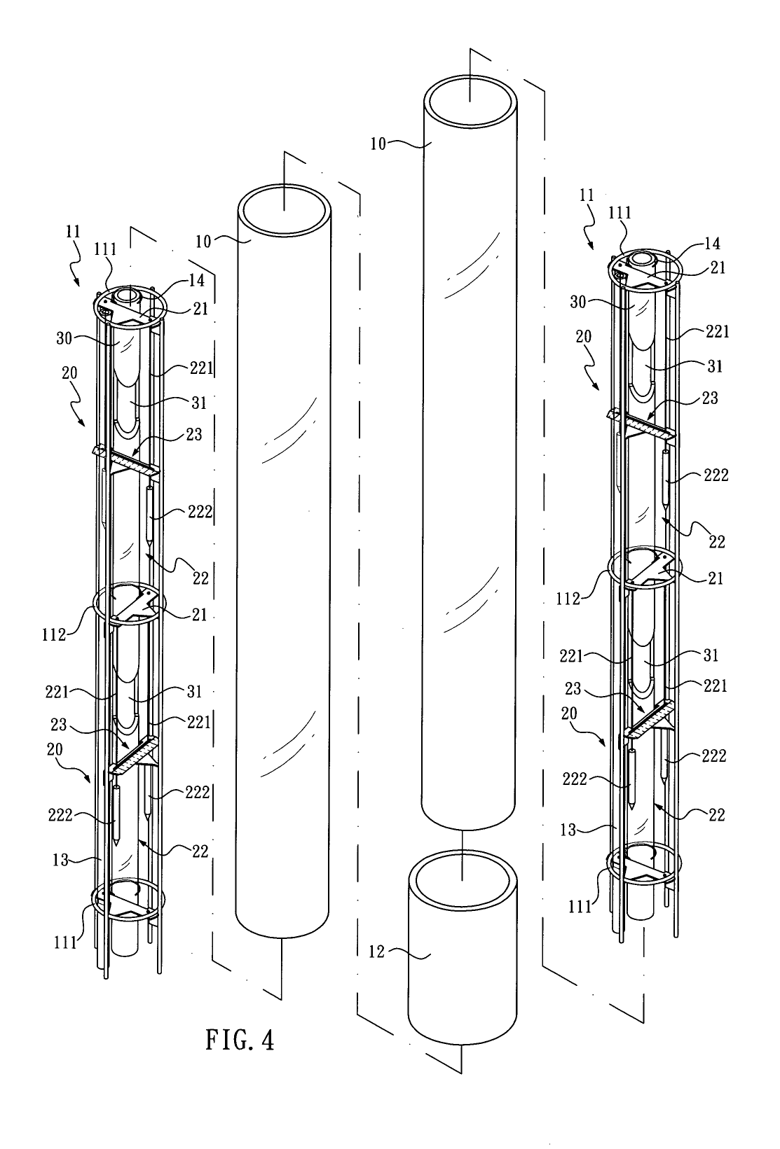

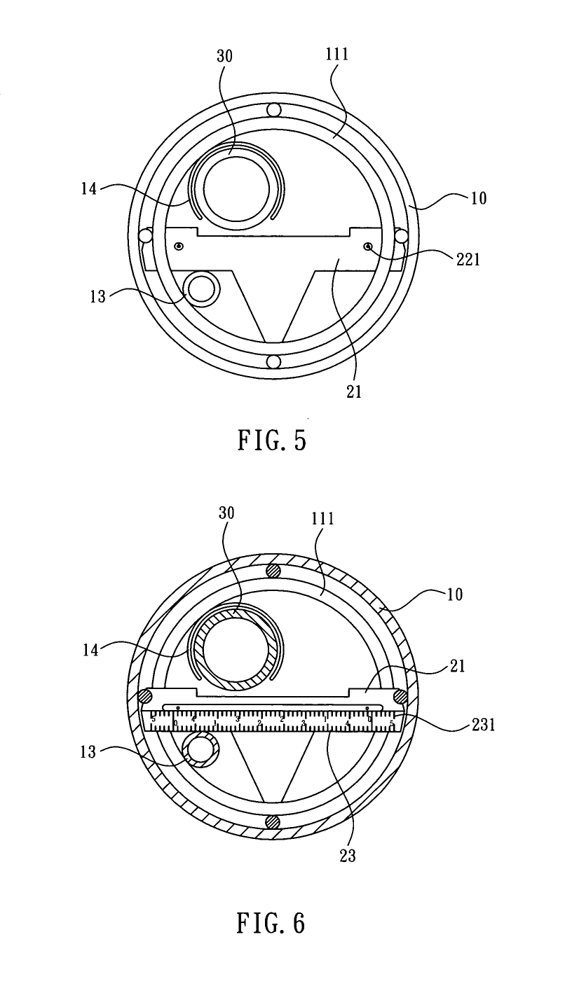

As shown in FIG. 2 through FIG. 6, the pendulum-type landslide monitoring system of the present invention primarily comprises: an outer tube 10, a plurality of measuring units 20, a guiding tube 30 and a flexible image capturing device 40. The outer tube 10 is to be inlaid and positioned in the observation well 4 reaching the laccolith 3. The measuring units 20 are arranged inside and along the outer tube 10, for measuring displacement of the outer tube 10 taking place at different depths underground. The guiding tube 30 is also in the outer tube 10. The flexible image capturing device 40 is electrically connected to a computer-controlling unit 50, and is hung into the guiding tube 30 by an electric cable 6 for capturing dynamic or static images.

The outer tube 10 may be a transparent plastic tube providing a total length equal to that of a conventional measuring tube, about 3,000 mm. For the convenience of manufacture and fabrication, the outer tube 10 may be composed of a plurality of sub-tubes. Those sub-tubes are vertically aligned and connected with a connecting sleeve 12 provided between two adjacent sub-tubes. The connecting sleeves 12 serve to join the sub-tubes into a unity.

Along the outer tube 10, plural frames 11 each as long as 600 mm are provided. The frame 11 has attaching rings 111 at its upper and lower ends, respectively. The frames 11 are positioned by the outer tube 10 and the connecting sleeves 12. In addition, the frame 11 has at least one linking ring 112 provided at its middle portion. A transparent water-level monitoring tube 13 is positioned beside the attaching rings 111 along the joined frames 11. The water-level monitoring tube 13 is communicated to the exterior of the outer tube 10 for drawing groundwater therein.

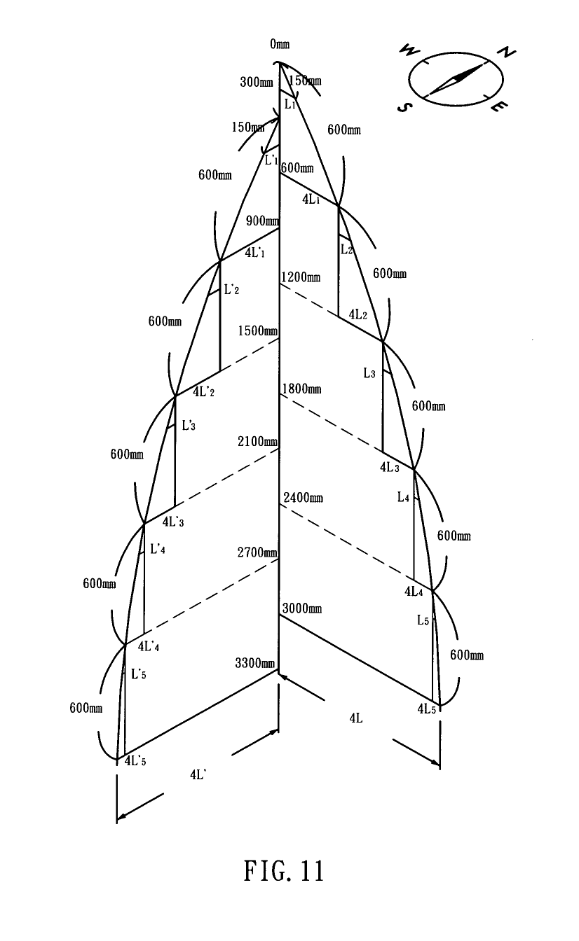

The measuring units 20 are deposited on the upper attaching rings 111 of the frames 11 and the linking rings 112 of the frames 11. Therein, the two measuring units 20 belonging the same frame 11 may be such arranged that the measuring unit 20 at the upper attaching ring 111 is laid in the east-west direction and the measuring unit 20 at the linking ring 112 is laid in the north-south direction. Therein, as shown in FIG. 11, the measuring units 20 in the east-west direction are 0 mm, 600 mm, 1200 mm, 1800 mm and 2400 mm deep from the earth's surface, respectively, with each separated by 600 mm. On the other hand, the measuring units 20 in the north-south direction are 300 mm, 900 mm, 1500 mm, 2100 mm and 2700 mm, deep from the earth's surface, respectively, each separated by 600 mm. The combination of the measuring units 20 deposited in alternate directions facilitates accurate measurement of the sliding azimuth of the sliding surface 5.

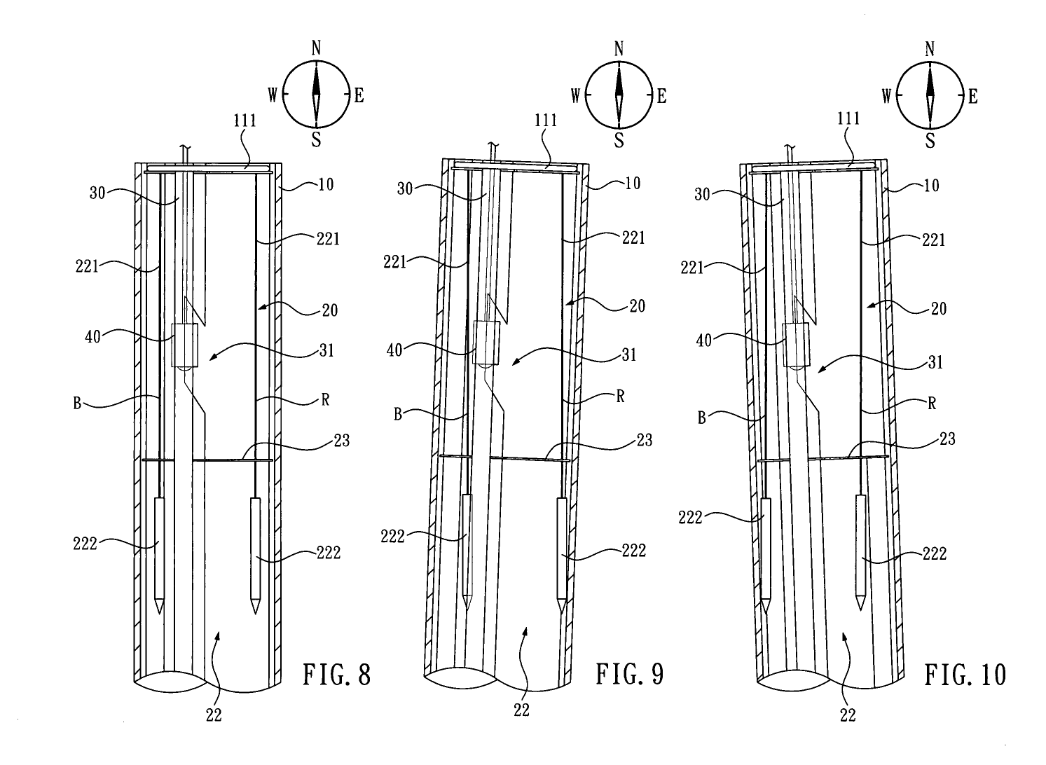

The measuring unit 20 comprises at least one crossbeam 21, on which a pendulum set 22 is provided. The pendulum set 22 includes a pair of plumblines 221 attached to two ends of the crossbeam 21. Each said plumbline 221 is distally equipped with a pendulum 222. A gauge 23 is provided on the frame 11 between the crossbeam 21 and the pendulum 222. The gauge 23 has two scales 231 for measuring the swings of the two plumblines 221, respectively. Therein, each said frame 11 has a maximum length as large as four times of the distance between the crossbeam 21 and the gauge 23. The two plumblines 221 of the pendulum set 22 may be of different colors for the convenience of recognizing their swings. For example, in the east-west-going measuring unit 20 at the attaching ring 111, one plumbline 221 near the slope of is a first color, and the other plumbline 221 near the valley is of a second color. However, the plumblines 221 may be colored anyway without limitation. For instance, the plumbline 221 near the wet slope 2 may be blue B and the other plumbline 221 near the east valley 1 may be red R, as shown in FIGS. 8, 9 and 10. Similarly, the plumblines 221 of the north-south-going measuring unit 20 at the linking ring 112 may also have different colors for easy reorganization, such as yellow and green. When the sliding surface 5 performs displacement, the plumblines 221 and the pendulums 222 oscillate in response. At this time, the different colors of the plumblines 221 help to indicate whether the sliding surface 5 moves toward the slope or the valley.

The guiding tube 30 may be a transparent tube set along inside the outer tube 10. The guiding tube 30 is fixed to the outer tube 10 through at least one fastener 14. The fastener 14 may be a fixing ring attached to the inner peripheral of the frame 11. However, the fastener 14 may be realized in any form without limitation, as long as it serves to position the guiding tube 30.

The flexible image capturing device 40 is an in-place camera, which movably extend along the guiding tube 30, for capturing dynamic or static images of the plumblines 221 in each said measuring unit 20. For allowing the flexible image capturing device 40 to capture images of the plumblines 221 swinging with respect to the scales 231 of the gauge 23, the guiding tube 30 is formed with windows 31 aligned with the measuring units 20.

With the components and configuration described above, the present invention works in the way given below.

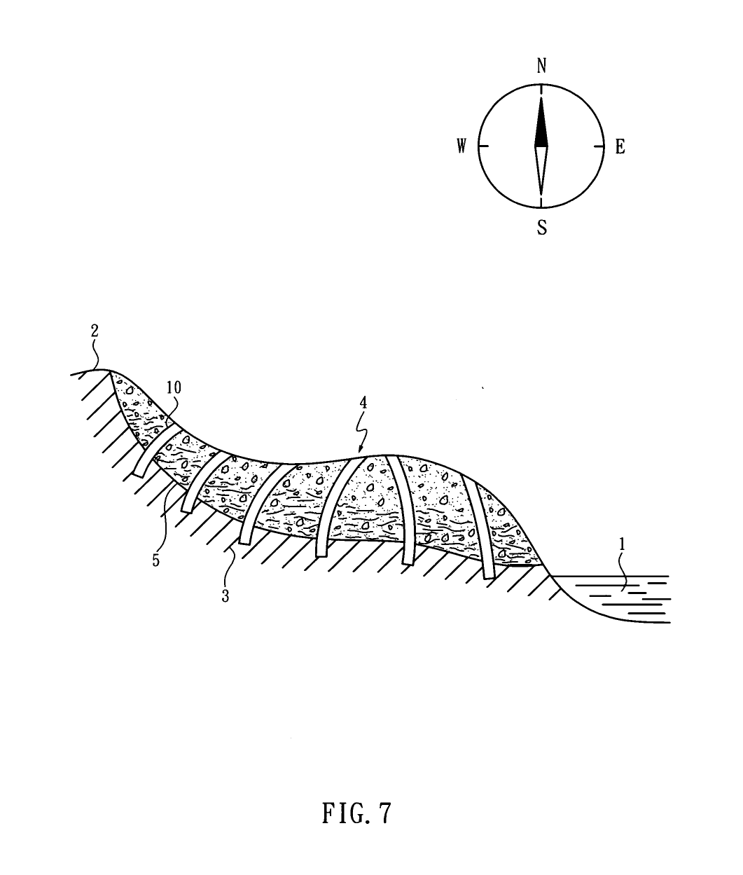

Referring to FIG. 8, before landslide, the outer tube 10 is vertically extended with the pendulum sets 22 perpendicular to the gauges 23. As shown in FIGS. 6, 7 and 9, when the sliding surface 5 slides from the slope 2 toward the valley 1 following the inclination of the landform, the west, blue plumbline 221 (B) hung on the crossbeam 21 near the slope 2 swings to the valley 1 in response to the displacement and the east, red plumbline 221 (R) hung on the crossbeam 21 near the valley 1 moves near the inner wall of the outer tube 10. At this time, the flexible image capturing device 40 can take the image of the scale 231 of the gauge 23 showing the distance the plumbline 221 moving toward the valley 1, and the directly observed reading of the scale 231 can be used to calculate the sliding azimuth and sliding amount of the sliding surface 5. Referring to FIG. 7 and FIG. 10, in case of landslide from the slope 2 toward the valley 1, the ground can press reversely to cause bulge near the valley 1. At this time, the east, red plumbline 221 (R) near the valley 1 swings along the sliding surface 5 toward the slope 2, and the west, blue plumbline 221 (B) near the slope 2 moves toward the inner wall of the outer tube 10. The flexible image capturing device 40 then can take the images of the scales 231 on the gauges 23 for indicating the displacement amount.

As the north-south-going measuring units 20 at the linking rings 112 work similarly, the detailed description is herein omitted. By using both east-west-going and north-south-going measuring units 20, the sliding azimuth of the sliding surface 5 can be accurately measured.

FIG. 11 illustrates how to use the swings of the plumblines 221 of both the east-west-going and north-south-going measuring units 20 to determine the displacement amount of the sliding surface 5. As described above, the total length of the outer tube 10 is 3000 mm, and each said frame 11 of 600 mm is provided with one east-west-going measuring unit 20 and one north-south-going measuring unit 20. In addition, with consideration of the diameter of the outer tube 10 and the convenience for calculation, the length of the frame 11 is four times of the distance between the crossbeam 21 and the gauge 23, so the distance between the crossbeam 21 and the gauge 23 is 150 mm. When the plumbline 221 of the upmost east-west-going pendulum set 22 swings for a distance L₁, according to the similarity theorem, the frame 11 has displaced by a distance 4L₁. From the swings of the plumblines 221 of all the frames 11, the displacement amounts of the outer tube 10 at different depths underground can be derived and in turn the displacement amount of the sliding surface 5 can be calculated, as the equations below:

ΣL (sum of swings of the east-west-going plumblines 221)=L₁+L₂+L₃+L₄+L₅

Displacement amount of the outer tube 10=4ΣL=4L₁+4L₂+4L₃+4L₄+4L₅

Similarly, when the plumbline 221 of the upmost north-south-going pendulum set 22 swings for a distance L′₁, the frame 11 has displaced by a distance 4 L′₁, and the north-south-going displacement amount of the sliding surface 5 can be obtained through following equations:

ΣL (sum of swings of the north-south-going plumblines 221)=L′₁+L′₂L′₃L′₄+L₅

Displacement amount of the outer tube 10=4ΣL′=4 L′₁+4L′₂+4L′₃+4 L′₄+4 L′₅

During groundwater monitoring, the in-place camera of the flexible image capturing device 40 preferably has its lens turned to face laterally for easily observing the water level in the water-level monitoring tube 13 and groundwater flow. While the groundwater under the sliding surface 5 flows, at least one pigment, such as uranine (sodium fluorescein) or food red, can be put into the upstream observation well 4. After a certain period of time, the colored groundwater flows to the downstream observation well 4, and since the outer tube 10, the guiding tube 30 and the water-level monitoring tube 13 are all transparent tubes, the flexible image capturing device 40 can directly take images inside the water-level monitoring tube 13 or outside the outer tube 10, to show the groundwater level and flow. Water stained by dissolved Uranine becomes reddish, indicating connection of groundwater veins. Thus, by observing all the observation wells 4, the groundwater flow pattern can be traced and identified. Also, the images of the observation wells 4 may be used to determine the groundwater depth and flow pattern, and the water level data over time can be used to produce a diagram of curves of water levels with coordinates, which can be read with the captured images to clearly tell the groundwater flow patterns, flow directions and variation at different depths.

In another embodiment of the present invention, the outer tube 10 and the guiding tube 30 are both non-transparent tubes. The flexible image capturing device 40 can take measuring results of the measuring units 20 through the windows 31. Additionally, since the groundwater outside the outer tube 10 can flow into the water-level monitoring tube 13, according to the u-tube principle, the water in the water-level monitoring tube 13 levels with the water outside the outer tube 10. Therefore, the images taken by the flexible image capturing device 40 through the windows 31 of the water-level monitoring tube 13 truly reflect the groundwater.

In different embodiments of the present invention, the flexible image capturing device 40 may be an IR thermometry camera. In such case, the outer tube 10, the guiding tube 30 and the water-level monitoring tube 13 can be transparent or non-transparent tubes. Since the soil water content outside the outer tube 10 can influence the temperature of the ground, it is feasible to use the IR thermometry camera that is temperature sensitive to sense the ground temperature, thereby getting information about the groundwater pattern at different depths, and identifying groundwater flow patterns.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A pendulum-type landslide monitoring system, comprising:
an outer tube for being implanted into a ground to be watched;
a plurality of measuring units vertically aligned inside the outer tube for independently measuring displacement at different depths in the ground; and
a guiding tube inside the outer tube for a flexible image capturing device to pass therethrough so that the flexible image capturing device is capable of moving along the guiding tube and capturing images outside the outer tube,
whereby, the flexible image capturing device along the guiding tube captures displacement data measured by the measuring units, thereby facilitating determining displacement of a sliding surface in the ground, and facilitating identifying groundwater levels and patterns by using images of flowing groundwater in the ground captured by the flexible image capturing device.

2. The pendulum-type landslide monitoring system of claim 1, wherein the outer tube is composed of a plurality of vertically aligned sub-tubes connected by a connecting sleeve provided therebetween, in which each of the sub-tube contains a frame that has at least one measuring unit.

3. The pendulum-type landslide monitoring system of claim 2, wherein each said frame has an upper end and a lower end equipped with a respective attaching ring that connects to the attaching ring of an adjacent said frame, in which the attaching ring at the upper end of the frame is equipped with one said measuring unit.

4. The pendulum-type landslide monitoring system of claim 3, wherein the frame has a middle portion provided with at least one linking ring, in which the linking ring is equipped with another said measuring unit whose working direction is perpendicular to a working direction of the measuring unit on the attaching ring at the upper end of the frame.

5. The pendulum-type landslide monitoring system of claim 2, wherein each said measuring unit comprises at least one crossbeam, a pendulum set deposited on the crossbeam, and a gauge set on the frame corresponding to each said pendulum set for measuring a swing of the pendulum set.

6. The pendulum-type landslide monitoring system of claim 5, wherein, each said pendulum set comprises two plumblines near two ends of the crossbeam, each said plumbline being distally provided with a pendulum, the gauge being positioned between the crossbeam and the pendulum, the gauge having two scales for measuring the swings of the two plumblines, and the two plumblines of the pendulum set being of different colors.

7. The pendulum-type landslide monitoring system of claim 1, wherein the guiding tube is positioned in the outer tube by at least one fastener.

8. The pendulum-type landslide monitoring system of claim 1, wherein the flexible image capturing device is an in-place camera or an IR thermometry camera

9. The pendulum-type landslide monitoring system of claim 8, wherein the guiding tube has windows each corresponding to one said measuring unit, so as to allow the flexible image capturing device to capture the displacement data measured by the corresponding measuring unit.

10. The pendulum-type landslide monitoring system of claim 8, wherein a water-level monitoring tube is provided inside the outer tube and communicating outside the outer tube.
